(19) United States
(12) Patent Application Publication
(10) Pub. No.: US 2020/0101802 A1
(43) Pub. Date: Apr. 2, 2020

(54) ADVANCED TIRE PRESSURE MONITORING SYSTEM WITH SOFTWARE AUTOLEARN

(71) Applicant: GM GLOBAL TECHNOLOGY OPERATIONS LLC, Detroit, MI (US)

(72) Inventors: Mohamed M. Nasser, Dearborn, MI (US); Douglas M. Kidd, Swartz Creek, MI (US)

(21) Appl. No.: 16/144,601

(22) Filed: Sep. 27, 2018

(51) Int. Cl. B60C 23/00; B60C 23/04; G06F 15/18

(52) U.S. Cl. CPC B60C 23/002; G06F 15/18; B60C 23/0489

(57) ABSTRACT

A tire pressure management system for a vehicle and method is disclosed. The system includes a first sensor sensitive to a rolling direction of a wheel and a second sensor sensitive to a steering ability of the wheel. A processor determines a location of the wheel at the vehicle from the rolling direction of the wheel and the steering ability of the wheel. The first sensor and second sensor can be part of a sensor package associated with the wheel that includes a tire pressure gage.

### INTRODUCTION

The subject disclosure relates to systems and methods of monitoring air pressure in tires of a vehicle and, in particular, systems and methods for learning tire location and pressure.

A tire pressure monitoring system includes a sensor within a tire that measures tire pressure and sends a signal to a vehicle's controller or driver. Current tire pressure systems have one sensor per tire. The location of the tire is recorded at the vehicle when the tire is installed. However, rotating tires from one location of the vehicle to another during routine maintenance results in misidentification of the tire location, so that it becomes difficult to determine which tire has low pressure when such a signal is received at the vehicle. Accordingly, it is desirable to provide a method by which a vehicle can automatically learn and/or identify the location of a tire in order to facilitate tire pressure maintenance.

### SUMMARY

In one exemplary embodiment, a method for managing tire pressure at a wheel of a vehicle is disclosed. The method includes determining a rolling direction of the wheel via a first sensor associated with the wheel, determining a steering ability of the wheel via a second sensor associated with the wheel, and determining, via a processor, a location of the wheel at the vehicle from the rolling direction and the steering ability.

In addition to one or more of the features described herein, the method includes measuring a tire pressure of a tire associated with the wheel via a pressure sensor associated with the wheel and associating, via the processor, the measured tire pressure with the location of the wheel. In various embodiments, the first sensor is a first accelerometer oriented along a first axis and the second sensor is a second accelerometer oriented along a second axis. The method includes transmitting a first binary signal indicative of the rolling direction to the processor, transmitting a second binary signal indicative of the steering ability to the processor, and determining, at the processor, the location of the wheel from the first binary signal and the second binary signal. The vehicle includes a dual wheel assembly at rear locations of the vehicle, each dual wheel assembly having an inboard wheel and an outboard wheel, further comprising identifying, at the processor, the inboard wheel from the outboard wheel. The method further includes determining identifying the inboard wheel from the outboard wheel using a correlation of time-stamped data from an anti-lock braking system and an angle of interest from time-stamped RF data. The method further includes learning, at the processor, sensor ID associated with the wheel upon securing the wheel to the vehicle.

In another exemplary embodiment, a tire pressure management system for a vehicle is disclosed. The system includes a first sensor sensitive to a rolling direction of a wheel, a second sensor sensitive to a steering ability of the wheel, and a processor configured to determine a location of the wheel at the vehicle from the rolling direction of the wheel and the steering ability of the wheel.

In addition to one or more of the features described herein, the system further includes a pressure sensor sensitive to a tire pressure of a tire associated with the wheel, wherein the processor associates the tire pressure with the determined location of the wheel. In various embodiments, the first sensor is a first accelerometer oriented along a first axis and the second sensor is a second accelerometer oriented along a second axis. The first sensor transmits a first binary signal related to rolling direction to the processor and the second sensor transmits a second binary signal related to steering ability to the processor, the processor further configured to determine the location of the wheel from the first binary signal and the second binary signal. The vehicle includes a dual wheel assembly at rear locations of the vehicle, each dual wheel assembly having an inboard wheel and an outboard wheel, the processor further configured to identify the inboard wheel from the outboard wheel. The processor is further configured to identify the inboard wheel from the outboard wheel using a correlation of time-stamped data from an anti-lock braking system and an angle of interest from time-stamped RF data. The processor is further configured to learn a sensor ID associated with the wheel upon securing the wheel to the vehicle.

In yet another exemplary embodiment, a tire pressure management system for a vehicle is disclosed. The vehicle includes a plurality of wheels. The system includes a plurality of sensor packages, each sensor package associated with a wheel selected from the plurality of wheels. Each sensor package includes a first sensor sensitive to a rolling direction of the wheel, and a second sensor sensitive to a steering ability of the wheel. A processor receives data from each of the plurality of sensor packages and determines a location of the associated wheels from the data.

In addition to one or more of the features described herein, the processor determines the location for a selected wheel from the rolling direction of the selected wheel and the steering ability of the selected wheel. In one embodiment, the first sensor is a first accelerometer oriented along a first axis and the second sensor is a second accelerometer oriented along a second axis. The sensor package transmits a first binary signal related to rolling direction and a second binary signal related to steering ability to the processor, the processor further configured to determine the location of the wheel associated with the sensor package from the first binary signal and the second binary signal. Each sensor package further includes an identification number and the processor is configured to learn the identification number of the sensor package upon securing the wheel associated with the sensor package to the vehicle. In an embodiment, each sensor package is attached to a its associated wheel.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a plan view of a vehicle having a tire pressure monitoring system (TPMS);

FIG. 2 shows a schematic diagram of a sensor package suitable for use with the TPMS in an embodiment;

FIG. 3 shows a plan view of the vehicle of FIG. 1 showing data collected by a rolling direction sensor of a sensor package;

FIG. 4 shows a plan view of the vehicle of FIG. 1 showing data collected by a steering status sensor of the sensor package;

FIG. 5 shows a high level flowchart for determining a location of a wheel on a vehicle;

FIG. 6 shows details of a process of the flowchart of FIG. 5 for learning sensor identifications;

FIG. 7 shows details of a decision making process of the flowchart of FIG. 5 for determining a location of a wheel;

FIG. 8 shows a dual wheel assembly illustrating a placement of sensor packages within the dual wheel assembly;

FIG. 9 shows a plan view of a vehicle having a front set of wheels and a back set of wheel that includes a dual wheel assembly, showing the rotation data for each of the wheel;

FIG. 10 shows a plan view of the vehicle of FIG. 9 illustrating the steering ability for each wheel as detected by a steering status detector;

FIG. 11 shows a high level flowchart for determining a location of a wheel on a vehicle having dual assembly wheels; and

FIG. 12 shows details of the decision making process of the flowchart of FIG. 11 for determining a location of a wheel.

### DETAILED DESCRIPTION

The following description is merely exemplary in nature and is not intended to limit the present disclosure, its application or uses. It should be understood that throughout the drawings, corresponding reference numerals indicate like or corresponding parts and features.

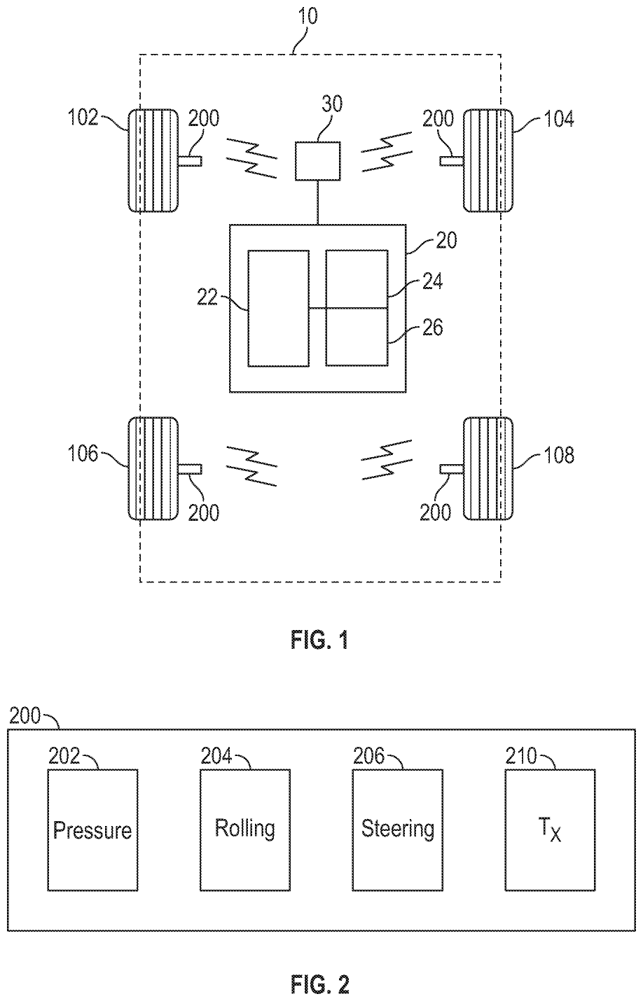

In accordance with an exemplary embodiment, FIG. 1 shows a plan view of a vehicle 10 having a tire pressure monitoring system (TPMS). For illustrative purposes, the vehicle 10 includes four wheel assemblies, where a wheel assembly includes a wheel and a tire. The wheel assemblies or wheels can be identified by their locations on the vehicle 10: a front left or front driver's side wheel 102, a front right or front passenger's side wheel 104, a rear left or rear driver's side wheel 106 and a rear right or rear passenger's side wheel 108. Each wheel assembly includes a sensor package 200 operative using the methods of the TPMS. The TPMS includes a control unit 20 in communication with the sensor package 200. The sensor package can be in wired communication with the control unit 20 or can send information to the control unit 20 wirelessly, for example, using radio frequency (RF) communication. The control unit includes a processor 22 and a memory storage device 24 accessible to the processor 22. The memory storage device 24 includes programs and/or instructions 26 that enable the processor 22 to perform the methods disclosed herein for locating a wheel position or location on the vehicle 10 and for determining a tire pressure for the associated tire. The control unit 20 is further in communication with a display 30 and sends data regarding tire pressure and wheel location to the display 30 for viewing by a user or driver of the vehicle 10.

FIG. 2 shows a schematic diagram of a sensor package 200 suitable for use with the TPMS in an embodiment. The sensor package 200 is affixed to the wheel assembly in order to have a selected orientation with respect to the wheel assembly. The sensor package 200 can be placed inside the wheel assembly in various embodiments. The sensor package 200 includes a tire pressure gage 202 for determining an air pressure of the tire (“tire pressure”). The sensor package 200 further includes a rolling direction sensor 204 and a steering status sensor 206. The rolling direction sensor 204 determines a direction in which the wheel rolls, i.e., either clockwise or counter-clockwise, as viewed from a selected frame of reference. In general, the driver's side wheels rotate in one direction, while the passenger's side wheels rotate in another direction. The steering status sensor 206 determine whether the wheel has the ability to rotate from side to side so as to steer the vehicle 10. The front wheels (102, 104) generally have the ability to rotate from side to side, while the back wheels (106, 108) generally do not have this ability. In various embodiments, the rolling direction sensor 204 is a first accelerometer and the steering status sensor 206 is a second accelerometer. The first accelerometer has is oriented along a first axis for detecting a rolling motion of its associated wheel. The second accelerometer is oriented along a second direction for detecting side to side motion of the associated wheel. The orientation of the accelerometer of the rolling direction sensor 204 is generally orthogonal to the orientation of the accelerometer of the steering status sensor 206.

The rolling direction sensor 204 and steering status sensor 206 provide their collected information to the control unit 20 and the control unit 20 determines the location of the wheel on the vehicle 10 from this information, as discussed below. In various embodiments, the sensor package 200 includes a transmitter 210 for transmitting the data collected by the tire pressure gage 202, the rolling direction sensor 204 and the steering status sensor 206 to the control unit 20 for processing.

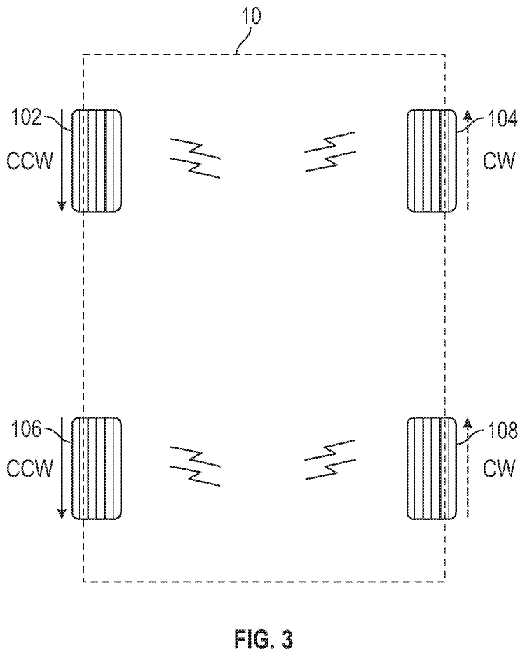

FIG. 3 shows a plan view of the vehicle 10 showing data collected by the rolling direction sensor 204. The driver's side wheels (102, 106) are have a direction of rotation of counter-clockwise (“CCW”), which is the direction of rotation when viewed looking at the vehicle 20 from the driver's side. The passenger's side wheels (104, 108) have a direction of rotation of clockwise (“CW”), which is the direction of rotation when viewed looking at the vehicle 20 from the passenger's side. It should be noted that the selection of counter-clockwise or clockwise is dependent upon a frame of reference of the observer and that these directions are changed when the rolling direction is viewed from a vantage point between the four wheels. The labels shown herein are therefore for illustrative purposes only. The rolling direction sensor 204 for an associated wheel provides its data (CW or CCW) to the control unit 20 for processing. In various embodiments, the data can be binary data where, for example, “1”=CW and “0”=CCW.

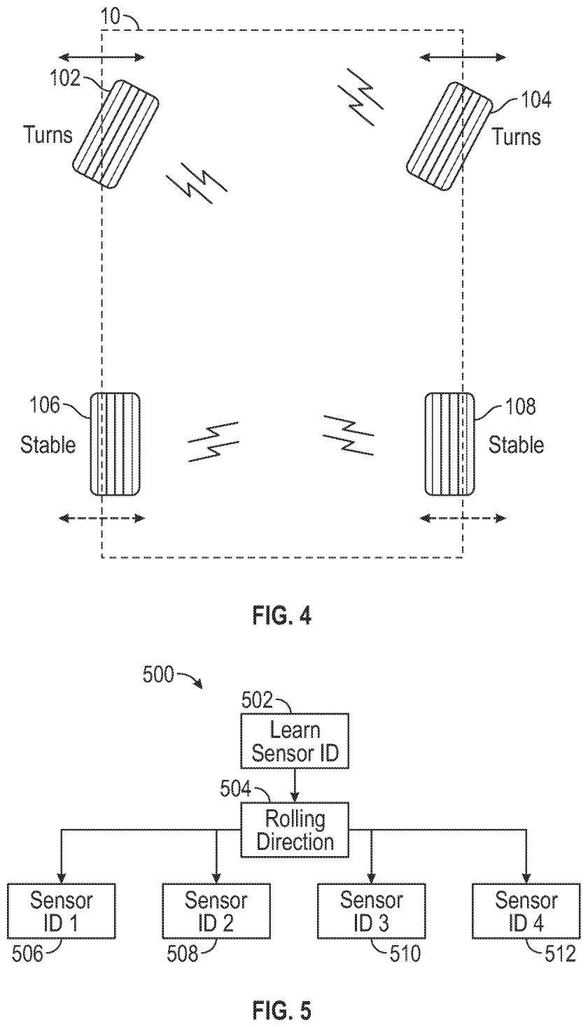

FIG. 4 shows a plan view of the vehicle 10 showing data collected by the steering status sensor 206. The front wheels (102, 104) have the ability to rotate from side to side. The back wheels (106, 108) do not have the ability to rotate from side to side. The steering status sensor 206 for an associated wheel provides its data (e.g., “turns” or “stable”) to the control unit 20 for processing. In various embodiments, the data can be binary data where, for example, “1”=“turns” and “0”=“stable”.

The processor 22 is therefore able to determine the location or position of a wheel or wheel assembly based on the data received from the rolling direction sensor 204 and the steering status sensor 206. Combining the binary data provides a unique binary signal (00, 01, 10, 11) that can be used to identify the location of the wheel. For example, a wheel with the binary signal of “11” rotates clockwise and has the ability to turn side to side and therefore can be identified as the front passenger's side wheel 104. A wheel with the binary signal “10” rotates clockwise and does not have the ability to turn side to side and therefore can be identified as the back passenger's side wheel 106.

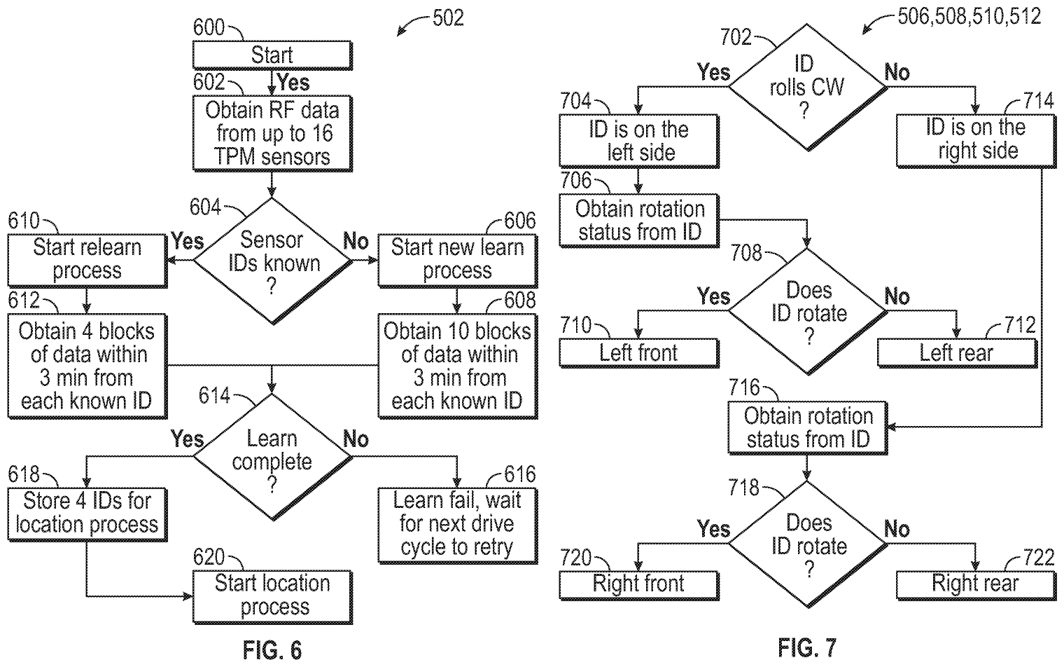

FIG. 5 shows a high level flowchart 500 for determining a location of a wheel or wheel assembly on a vehicle. In box 502, the process obtains identification numbers for each sensor, which are then used to identify the associated wheel. Details of box 502 are discussed below with respect to FIG. 6. Still referring to FIG. 5, in box 504 the wheel location process is begun by obtaining a wheel's rolling direction from each sensor. For each sensor ID, a decision making process is performed in order to determine the location of the wheel. Box 506 is the decision making process for the first sensor ID, box 508 is the decision making process for the second sensor ID, box 510 is the decision making process for the third sensor ID, and box 512 is the decision making process for the fourth sensor ID. Each of boxes 506, 508, 510 and 512 perform the same decision making process, which is discussed in detail with respect to FIG. 7.

FIG. 6 shows the details of box 502 of the flowchart 500 for learning sensor identifications (sensor IDs). The process begins at box 600. In box 602, RF data for sensor ID is received from one or more sensors disposed on the vehicle. In box 604, the control unit 20 determines whether the sensor IDs are known or not. If the sensor IDs are not known, the process continues at box 606. At box 606, a learning process is begun. In box 608, the control unit 20 receives a selected number of blocks (e.g, 10 blocks) of data within a selected period of time (e.g., 3 minutes from each sensor ID), the blocks of data including the sensor ID. When this occurs, the control unit 20 is able to determine that a new wheel and sensor ID have been added to the vehicle. Returning to box 604, if the sensors ID is known, the process continues at box 610. At box 610, a relearning process is begun. In box 612, the control unit 20 receives a selected number of blocks (e.g., 4 blocks) of data from each known sensor ID within a selected period of time (e.g., 3 minutes). This amount of data confirms that the sensor ID still remains within the TPMS.

After either the learning process (boxes 606, 608) or the relearning process (boxes 610, 612), then at box 614, the control unit 20 determines whether the learning or relearning process is complete. If not, then at box 616, the process waits for a next drive cycle in order to attempt to determine the sensor IDs. If the sensor IDs have been learned, then at box 618, the sensor IDs are stored in memory. In box 620, based on the sensor ID, the process continues to one of boxes 504, 506, 508, 510 and 512, which are discussed in detail below with respect to FIG. 7.

FIG. 7 shows details of the decision making process of any of boxes 506, 508, 510 and 512 of FIG. 5 for determining a location of a wheel. At box 702, a decision is made whether the wheel rolls clockwise or counter-clockwise. If the wheel e rolls clock-wise, the method proceeds to box 704. In box 704, a determination is (from the wheel rolling clockwise) that the wheel is on the left or driver's side of the vehicle. In box 706, the steering status of the wheel is obtained. In box 708, a decision is made regarding the steering status of the wheel. If the wheel can turn from side to side, then the process continues to box 710 in which it is determined that the wheel is the front driver's side wheel (e.g., wheel 102). However if, at box 708, it is determined that the wheel cannot turn from side to side, then the process continues to box 712 in which it is determined that the wheel is the rear driver's side wheel (e.g., wheel 106).

Returning to box 702, if the wheel rolls counter-clockwise, the method proceeds to box 714. At box 714, a determination is made (from the wheel rolling counter-clockwise) that the wheel is on the right or passenger's side of the vehicle. In box 716, the steering status of the wheel is obtained. In box 718, a decision is made regarding the steering status of the wheel. If the wheel can turn side to side, then the process continues to box 720 in which it is determined that the wheel is the front passenger's side wheel (e.g., wheel 104). However, if at box 718, it is determined that the wheel cannot turn side to side, then the process continues to box 722 in which it is determined that the wheel is the rear passenger's side wheel (e.g., wheel 108).

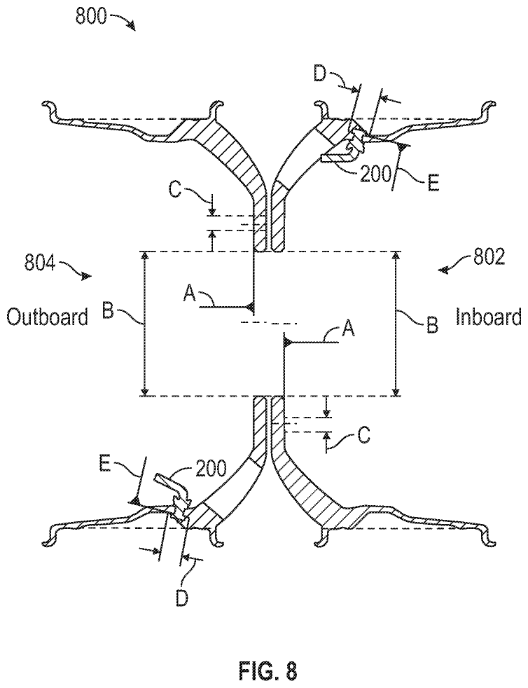

FIG. 8 shows a dual wheel assembly 800 illustrating a placement of the sensor packages 200 with respect to the dual wheel assembly 800. A dual wheel assembly 800 is generally located at a rear of various vehicles, such as trucks, tractor trail rigs or long-haul trucks. The dual wheel assembly 800 includes an inboard wheel 802 and an outboard wheel 804. In various embodiments, a sensor package is included in the inboard wheel 802 and another sensor package is included in the outboard wheel 804. The sensor package of the inboard wheel 802 is oriented so that its rolling direction sensor oriented along one axis while the sensor package of the outboard wheel 804 is oriented so that its rolling direction sensor is oriented along the same axis but in the opposite direction. Therefore, the sensor package for the inboard wheel 802 indicate the rotation direction of the inboard wheel 802 as one of clockwise and counter-clockwise while the sensor package of the outboard wheel 804 indicates the rolling direction of the outboard wheel 804 as the other of clockwise and counter-clockwise. The differences in rolling direction can be used to differentiate the inboard wheel 802 from the outboard wheel 804. Additionally, the valve stem (and thus the sensor package) for the inboard wheel 802 is 180 degrees opposite the valve stem (and thus the sensor package) for the outboard wheel 804. This difference in rotation angle can be used to differentiate inboard wheel 802 from outboard wheel 804.

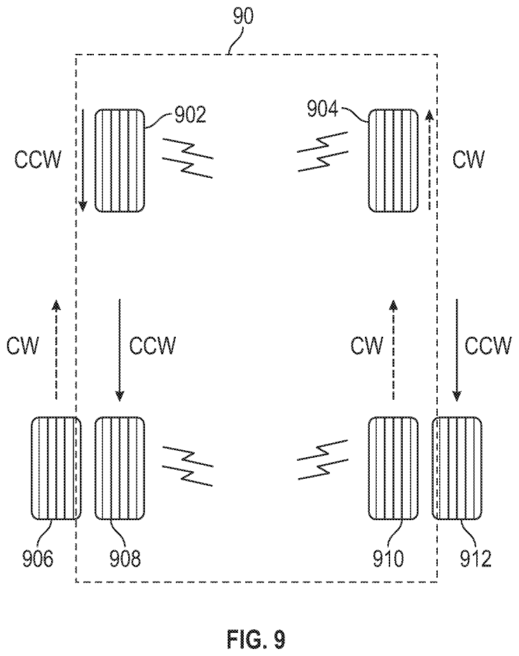

FIG. 9 shows a plan view of a vehicle 90 having a front set of wheels (902, 904) and a back set of wheels that includes a dual tire assembly. On the rear driver's side, the assembly includes an outboard wheel 906 and an inboard wheel 908. On the rear passenger's side, the assembly includes an inboard wheel 910 and an outboard wheel 912. FIG. 9 shows rolling directions determined by the rolling direction sensors associated with each wheel. The front driver's side wheel 902 has a detected rolling direction of CCW and the front passenger's side wheel 904 has a rolling direction of CW. The rear driver's side outboard wheel 906 has a detected rolling direction of CW and the rear driver's side inboard wheel 908 has a detected rolling direction of CCW. On the passenger's side, the rear passenger's side inboard wheel 910 has a detected rolling direction of CW and the rear passenger's side outboard wheel 912 has a detected rolling direction of CCW.

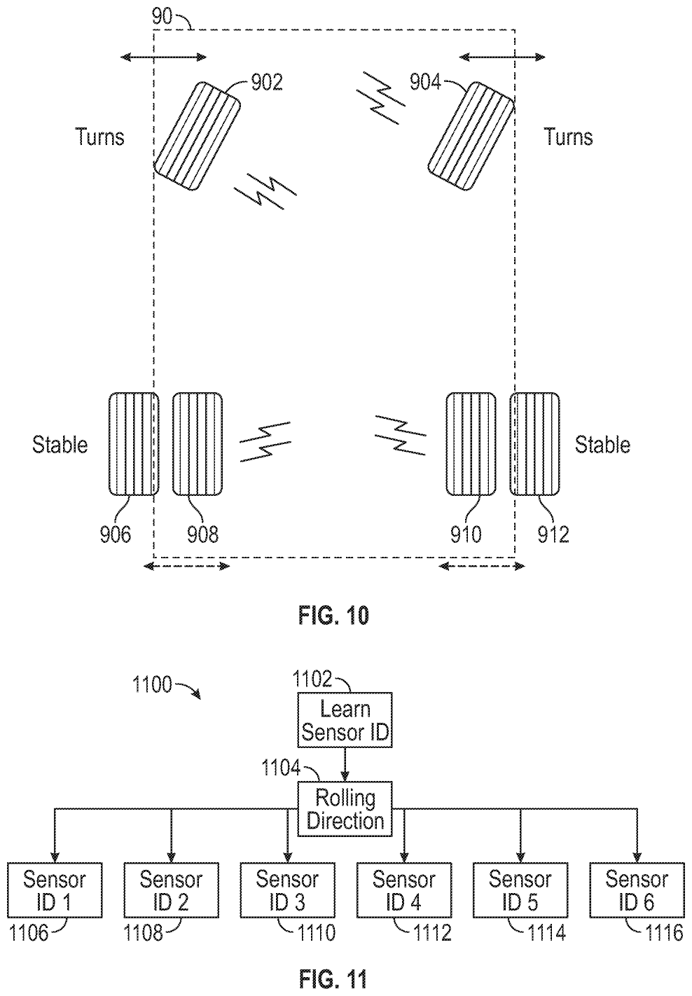

FIG. 10 shows a plan view of the vehicle 90 of FIG. 9 illustrating the steering ability for each wheel as detected by the steering status detector. The front wheels 902 and 904 have a detected steering status of “turnable.” The rear wheels 906, 908, 910 and 912 have a detected steering status of “stable.”

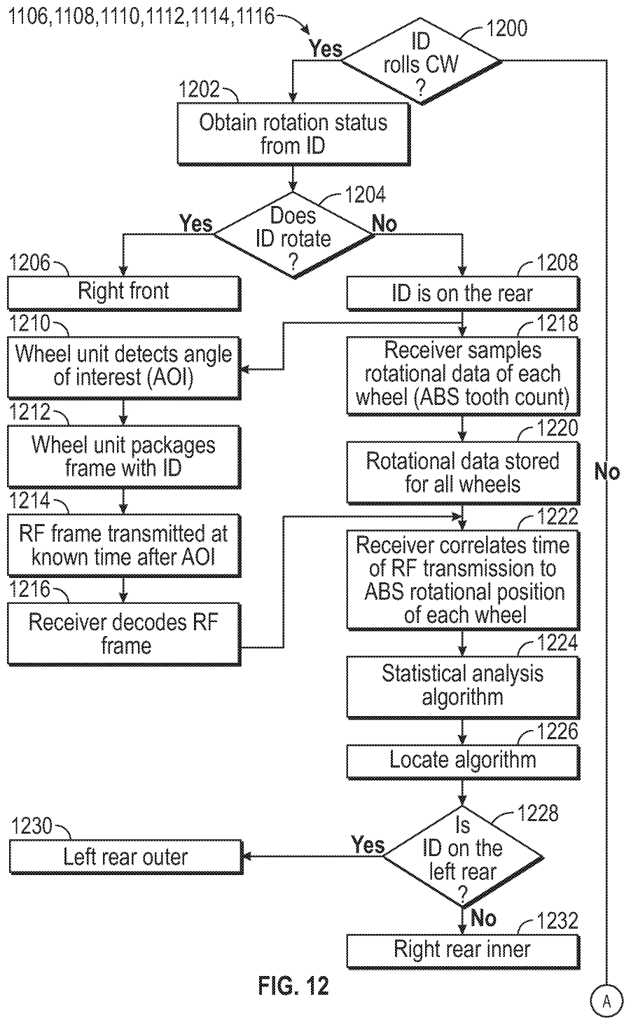

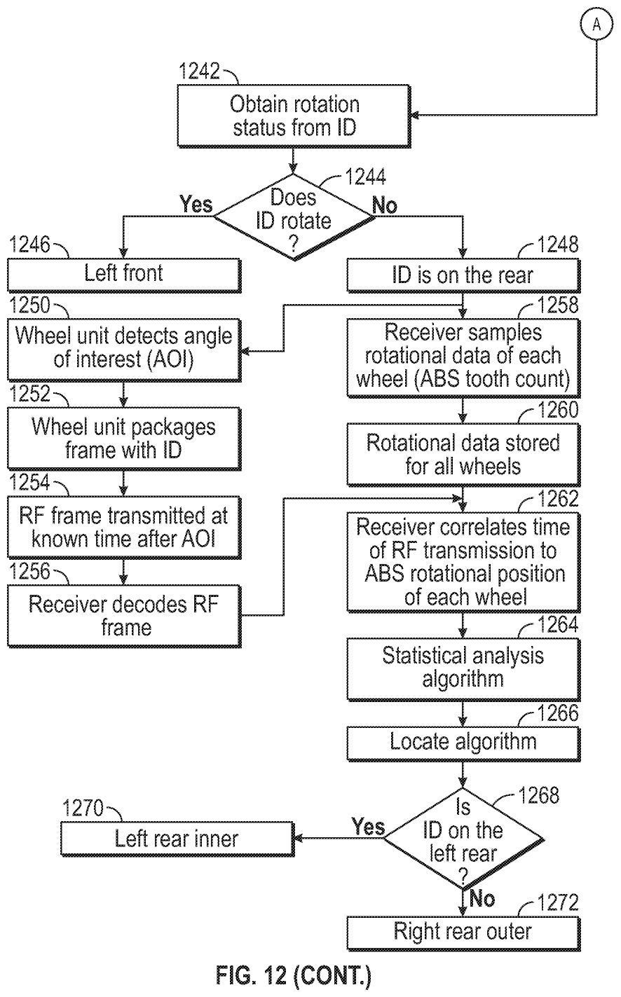

FIG. 11 shows a high level flowchart 1100 for determining a location of a wheel on a vehicle having dual assembly wheels at the rear locations. In box 1102, the process obtains identification numbers for each sensor, which are then used to identify the associated wheel. The details of box 1102 are the same as those discussed in FIG. 6, for 6 sensor IDs rather than 4 sensor IDs. In box 1104, the wheel location process is begun by obtaining a wheel rolling direction from each sensor. For each sensor ID, a decision making process is performed in order to determine the location of the wheel. Boxes 1106, 1108, 1110, 1112, 1114 and 1116 are decision making processes for each of the sensor IDs. Each of boxes 1106, 1108, 1110, 1112, 1114 and 1116 perform the same decision making process, which is discussed in detail with respect to FIG. 12.

FIG. 12 shows details of the decision making process of boxes 1106, 1108, 1110, 1112, 1114 and 1116 of FIG. 11 for determining a location of a wheel. At box 1200, a decision is made whether the wheel rolls clockwise or counter-clockwise. If the wheel rolls clock-wise, the method proceeds to box 1202. In box 1202, a steering status for the wheel is obtained. In box 1204, a decision is made (from the steering status) based on the rotation and steering status. If the wheel is able to steer, the process continues to box 1206. At box 1206 since the wheel is steerable, it is at the front of the vehicle and is therefore wheel 902. If the wheel cannot steer, then the process continues to box 1208. At box 1208, the wheel is determined to be a rear wheel.

From boxes 1208 to 1226, the process determines whether the rear wheel is on the left or right side of the vehicle, thereby providing information to determine the location of the rear wheel at the dual wheel assemblies. In particular, the process determines a correlation between two rotational speed measurements as the wheel is used, thereby determining the side of the car by correlating changes in the speed of the rotation of the wheel with the direction of turn.

In particular, from box 1208, two branches of operations are performed. The first branch includes boxes 1210, 1212, 1214 and 1216 and determines an angle of interest of the wheel. The angle of interest can be related to the location of the valve stem of the wheel during rotation of the wheel and indicates a starting rotation angle of the wheel. The second branch includes boxes 1218 and 1220 and determines rotational data of the wheel.

Specifically in box 1210, the sensor package detects the angle of interest (AOI) of the wheel, for example, detects when the sensor package is at a lowest point in the rotation of the wheel. In box 1212, the sensor package packages the angle of interest within a radio frequency (RF) frame to indicate a rotational position of the wheel to the control unit. In box 1214, the RF frame is sent to the control unit 20 each time the wheel passes through the angle of interest. In box 1216, the control unit 20 decodes the RF frame to track the rotation of the wheel. In the second branch, in box 1218 the control unit 20 samples rotation of a gear of an anti-lock brake (ABS) system, in particular, by counting a number of teeth (“tooth count”) of the gear passing a sensor in the wheel. In box 1220, the rotational data or tooth count is tracked and stored for all wheels.

In box 1222, the control unit 20 correlates the times provided by the RF transmission with the ABS rotational position (i.e., tooth counts) of each wheel. In box 1224, a statistical analysis is performed using the correlation of data. In box 1226, a location analysis is performed on the correlation to determine the location of the wheel (i.e., the side of the vehicle) from the statistical analysis.

In box 1228, a decision is made based on whether the wheel is on the left side (driver's side) of the vehicle or on the right side (passenger's side) of the vehicle. If the wheel is on the left side of the vehicle, then the process continues to box 1230 in which it is determined that the wheel is the rear driver's side outboard wheel (i.e., wheel 906). If the wheel is on the right side of the vehicle, then the process continues to box 1232 in which it is determined that the wheel is the rear passenger's side inboard wheel (i.e., wheel 910).

Returning to box 1200, if the wheel rolls counter-clockwise, the method proceeds to box 1242. In box 1242, a steering status for the wheel is obtained. In box 1244, a decision is made (from the steering status) based on the rotation and steering status. If the wheel is able to steer, the process continues to box 1246. At box 1246 since the wheel is steerable, it is at the front of the vehicle and is therefore wheel 904. If the wheel cannot steer, then the process continues to box 1248, where the wheel is determined to be a rear wheel.

From box 1248, two branches of operations are performed. The first branch includes boxes 1250, 1252, 1254 and 1256 and determines an angle of interest of the wheel. The angle of interest can be related to the location of the valve stem of the wheel during rotation of the wheel. The second branch includes boxes 1258 and 1260 and determines rotational data of the wheel.

Specifically in box 1250, the sensor package detects the angle of interest (AOI) of the wheel, for example, detectors when the sensor package is at a lowest point in the rotation of the wheel. In box 1252, the sensor package packages the angle of interest with an RF frame to indicate a rotational position of the wheel of the control unit. In box 1254, the RF frame is sent to the control unit 20 each time the wheel passes through the angle of interest. In box 1256, the control unit 20 decodes the RF frame to track the rotation of the wheel. In the second branch, in box 1258 the control unit 20 samples rotational data of the wheels by obtaining a tooth count of the (ABS) system of the wheel. In box 1260, the rotational data or tooth count is tracked and stored for all wheels.

In box 1262, the control unit 20 correlates the time provided by the RF transmission with the tooth counts of each wheel. In box 1264, a statistical analysis is performed using the correlation of data. In box 1266, a location analysis is performed on the correlation to determine the location of the wheel (i.e., the side of the vehicle) from the statistical analysis.

In box 1268, a decision is made based on whether the wheel is on the left side (driver's side) of the vehicle or on the right side (passenger's side) of the vehicle. If the wheel is on the left side of the vehicle, then the process continues to box 1270 in which it is determined that the wheel is the rear driver's side inboard wheel (i.e., wheel 908). If the wheel is on the right side of the vehicle, then the process continues to box 1272 in which it is determined that the wheel is the rear passenger's side outboard wheel (i.e., wheel 912).

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method for determining a location of a wheel at a vehicle, comprising:
affixing a sensor package to the wheel, the sensor package including a first accelerometer and a second accelerometer;
determining a rolling direction of the wheel via the first accelerometer;
determining a steering ability of the wheel via the second accelerometer; and
determining, via a processor, a location of the wheel at the vehicle from the rolling direction and the steering ability.

2. The method of claim 1, further comprising measuring a tire pressure of a tire associated with the wheel via a pressure sensor associated with the wheel and associating, via the processor, the measured tire pressure with the location of the wheel.

3. The method of claim 1, wherein the first accelerometer is oriented along a first axis and the second accelerometer is oriented along a second axis orthogonal to the first axis.

4. The method of claim 1, further comprising transmitting a first binary value indicative of the rolling direction to the processor, transmitting a second binary value indicative of the steering ability to the processor, and determining, at the processor, the location of the wheel from the first binary value and the second binary value.

5. The method of claim 1, wherein the vehicle includes a dual wheel assembly at rear locations of the vehicle, each dual wheel assembly having an inboard wheel with an inboard wheel sensor package and an outboard wheel with an outboard wheel sensor package, the first accelerometer of the inboard wheel sensor package being orientated along a first axis and the first accelerometer of the outboard wheel sensor package being orientated along the first axis in an opposite direction as the first accelerometer of the inboard wheel sensor package, further comprising differentiating, at the processor, the inboard wheel from the outboard wheel from differences in rolling direction indicated by the first accelerometer of the inboard wheel sensor package and the first accelerometer of the outboard wheel sensor package.

6. The method of claim 5, wherein the inboard wheel sensor package is 180 degrees opposite the outboard wheel sensor package, further comprising differentiating the inboard wheel from the outboard wheel using a difference in rotational angle of the inboard wheel sensor package and the outboard wheel sensor package.

7. The method of claim 1, further comprising learning, at the processor, a sensor ID associated with the wheel.

8. A system for determining a location of a wheel at a vehicle, comprising:
a sensor package affixed to the wheel, the sensor package including a first accelerometer sensitive to a rolling direction of a wheel and
a second accelerometer sensitive to a steering ability of the wheel; and
a processor configured to determine a location of the wheel at the vehicle from the rolling direction of the wheel and the steering ability of the wheel.

9. The system of claim 8, the sensor package further comprising a pressure sensor sensitive to a tire pressure of a tire associated with the wheel, wherein the processor associates the tire pressure with the determined location of the wheel.

10. The system of claim 8, wherein the first accelerometer is oriented along a first axis and the second accelerometer is oriented along a second axis orthogonal to the first axis.

11. The system of claim 8, wherein the first accelerometer transmits a first binary value related to rolling direction to the processor and the second accelerometer transmits a second binary value related to steering ability to the processor, the processor further configured to determine the location of the wheel from the first binary value and the second binary value.

12. The system of claim 8, wherein the vehicle includes a dual wheel assembly at rear locations of the vehicle, each dual tire assembly having an inboard wheel with an inboard wheel sensor package and an outboard wheel with an outboard wheel sensor package, the processor further configured to identify the inboard wheel from the outboard wheel, the first accelerometer of the inboard wheel sensor package being orientated along a first axis and the first accelerometer of the outboard wheel sensor package being orientated along the first axis in an opposite direction as the first accelerometer of the inboard wheel sensor package.

13. The system of claim 12, wherein the inboard wheel sensor package is 180 degrees opposite the outboard wheel sensor package, wherein the processor is further configured to differentiate the inboard wheel from the outboard wheel using a difference in rotational angle of the inboard wheel sensor package and the outboard wheel sensor package.

14. The system of claim 8, wherein the processor is further configured to learn a sensor ID associated with the wheel.

15. A system for determining a location of a wheel at a vehicle, comprising:
a plurality of wheels on the vehicle;
a plurality of sensor packages, each sensor package affixed to an associated wheel selected from the plurality of wheels, each sensor package including:
a first accelerometer sensitive to a rolling direction of the associated wheel; and
a second accelerometer sensitive to a steering ability of the associated wheel; and
a processor configured to receive data from each of the plurality of sensor packages and determines a location of the associated wheels from the data.

16. The system of claim 15,
wherein the processor determines the location for a selected wheel from the rolling direction of the selected wheel and the steering ability of the selected wheel.

17. The system of claim 15, wherein the first accelerometer is oriented along a first axis and the second accelerometer is oriented along a second axis orthogonal to the first axis.

18. The system of claim 15, wherein the sensor package transmits a first binary value related to rolling direction and a second binary value related to steering ability to the processor, the processor further configured to determine the location of the wheel associated with the sensor package from the first binary value and the second binary value.

19. The system of claim 15,
wherein each sensor package further includes an identification number and the processor is configured to learn the identification number of the sensor package.

20. The system of claim 15, wherein each sensor package is attached to its associated wheel.
